(19) United States
(12) Patent Application Publication
(10) Pub. No.: US 2007/0103053 A1
(43) Pub. Date: May 10, 2007

(54) IMAGE DISPLAY DEVICE

(76) Inventors: Nobuyuki AOYAMA, Hiratsuka-shi (JP); Sachiko HIRAHARA, Fukaya-shi (JP); Satoshi ISHIKAWA, Fukaya-shi (JP); Satoko OYAIZU, Fukaya-shi (JP); Kentaro SHIMAYAMA, Fukaya-shi (JP); Ken TAKAHASHI, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/619,312

(22) Filed: Jan. 3, 2007

Related U.S. Application Data
(63) Continuation of application No. PCT/JP05/12496, filed on Jul. 6, 2005.

(30) Foreign Application Priority Data
Jul. 9, 2004 (JP) 2004-203401

(51) Int. Cl. H01J 1/62; H01J 63/04

(52) U.S. Cl. 313/497; 313/495

(57) ABSTRACT

Spacers and a grid unit are provided between a first substrate having a phosphor screen formed thereon and a second substrate provided with a plurality of electron emission sources. The grid unit includes a plate-shaped grid which has a plurality of electron beam apertures opposed to the electron emission sources, individually, and is located opposite the second substrate and to which a predetermined voltage is applied, and a first dielectric layer which covers an outer surface of the grid. The grid unit includes a conductive layer, which is provided between the first dielectric layer and the second substrate and connected to a ground potential, and a second dielectric layer formed covering the conductive layer and situated between the conductive layer and the second substrate.

### CROSS-REFERENCE TO RELATED APPLICATIONS

This is a Continuation Application of PCT Application No. PCT/JP2005/012496, filed Jul. 6, 2005, which was published under PCT Article 21(2) in Japanese.

This application is based upon and claims the benefit of priority from prior Japanese Patent Application No. 2004-203401, filed Jul. 9, 2004, the entire contents of which are incorporated herein by reference.

### BACKGROUND OF THE INVENTION

1. Field of the Invention

This invention relates to an image display device provided with substrates located opposite each other and spacers arranged between the substrates.

2. Description of the Related Art

In recent years, various flat image display devices have been noticed as a next generation of lightweight, thin display devices to replace cathode-ray tubes (CRTs). For example, a surface-conduction electron emission device (SED) has been developed as a kind of a field emission device (FED) that functions as a flat display device.

The SED comprises a first substrate and a second substrate that are located opposite each other with a predetermined space between them. These substrates have their respective peripheral portions joined together by a rectangular sidewall, thereby forming a vacuum envelope. Three-color phosphor layers are formed on the inner surface of the first substrate. Arranged on the inner surface of the second substrate are a large number of electron emitting elements, which correspond to pixels, individually, and serve as electron emission sources that excite the phosphors. In order to support an atmospheric load that acts between the first substrate and the second substrate and maintain the gap between the substrates, a plurality of spacers are arranged between the two substrates. According to a device described in Jpn. Pat. Appln. KOKAI Publication No. 2002-082850, for example, a supporting substrate is provided between the first substrate and the second substrate, and the plurality of spacers are set up on the supporting substrate. The supporting substrate is formed having a plurality of electron beam apertures through which electron beams emitted individually from the electron emitting elements pass.

In displaying an image on the SED described above, an anode voltage is applied to the phosphor layers, and the electron beams emitted from the electron emitting elements are accelerated by the anode voltage and collided with the phosphor layers. Thereupon, the phosphors glow and display the image. In order to obtain practical display characteristics, it is necessary to use phosphors similar to those of conventional cathode ray tubes and set the anode voltage to several kV or more, and preferably, to 5 kV or more.

In the SED constructed in this manner, the luminance of the displayed image depends on the anode voltage, so that the anode voltage should preferably be high. In view of the resolution and the properties and manufacturability of supporting members, however, the gap between the first substrate and the second substrate is set to a relatively small value, e.g., about 1 to 2 mm. If a high voltage is applied, an intense electric field is inevitably formed in the small gap between the first substrate and the second substrate, so that electric discharge (dielectric breakdown) easily occurs between the two substrates. If the electric discharge occurs, breakdown or degradation of the electron emitting elements, a phosphor screen, or wires on the first substrate may possibly be caused. The electric discharge that results in the occurrence of such failure is not desirable in products.

### BRIEF SUMMARY OF THE INVENTION

This invention has been made in consideration of these circumstances, and its object is to provide an image display device with improved reliability and display quality in which the occurrence of electric discharge is suppressed.

In order to achieved the object, according to an aspect of the invention, there is provided an image display device comprising: a first substrate having a phosphor screen formed thereon; a second substrate located opposite the first substrate with a gap and provided with a plurality of electron emission sources which excite the phosphor screen; a plurality of spacers which are located between the first and second substrates and support an atmospheric load acting on the first and second substrates; and a grid unit provided between the spacers and the second substrate, the grid unit including a plate-shaped grid which has a plurality of electron beam apertures opposed to the electron emission sources, individually, and is located opposite the second substrate and to which a predetermined voltage is applied, a first dielectric layer which covers an outer surface of the grid, a conductive layer provided between the first dielectric layer and the second substrate and connected to a ground potential, and a second dielectric layer formed covering the conductive layer and situated between the conductive layer and the second substrate.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an SED according to a first embodiment of this invention;

FIG. 2 is a perspective view of the SED, broken away along line II-II of FIG. 1;

FIG. 3 is a sectional view enlargedly showing the SED;

FIG. 4 is a plan view showing a grid unit of the SED; and

FIG. 5 is a sectional view showing an SED according to a second embodiment of this invention.

### DETAILED DESCRIPTION OF THE INVENTION

A first embodiment in which this invention is applied to an SED as a flat image display device will now be described in detail with reference to the drawings.

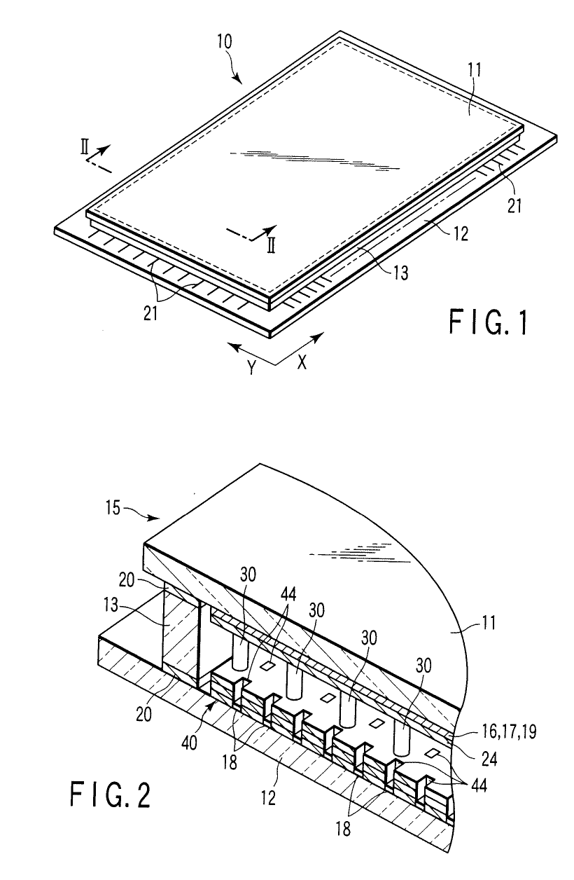

As shown in FIGS. 1 to 3, the SED comprises a first substrate 11 and a second substrate 12, which are formed of a rectangular glass plate each. These substrates are located opposite each other with a gap of about 1.0 to 2.0 mm between them. The first substrate 11 and the second substrate 12 have their respective peripheral edge portions joined together by a sidewall 13 of glass in the form of a rectangular frame, thereby forming a flat vacuum envelope 10 of which the inside is kept vacuum.

A phosphor screen 16 that functions as a phosphor screen is formed on the inner surface of the first substrate 11. The phosphor screen 16 is composed of phosphor layers R, G and B, which glow red, blue, and green, individually, and light shielding layers 15 arranged side by side. These phosphor layers are stripe-shaped, dot-shaped, or rectangular. A metal back 17 of aluminum or the like and a getter film 19 are successively formed on the phosphor screen 16.

Provided on the inner surface of the second substrate 12 are a large number of surface-conduction electron emitting elements 18, which individually emit electron beams as electron sources for exciting the phosphor layers R, G and B of the phosphor screen 16. These electron emitting elements 18 are arrayed in a plurality of columns and a plurality of rows corresponding to individual pixels. Each electron emitting element 18 is formed of an electron emitting portion (not shown), a pair of element electrodes that apply voltage to the electron emitting portion, etc. A large number of wires 21 for driving the electron emitting elements 18 are provided in a matrix on the inner surface of the second substrate 12, and their respective end portions are led out of the vacuum envelope 10.

The sidewall 13 that functions as a joint member is sealed to the peripheral edge portion of the first substrate 11 and the peripheral edge portion of the second substrate 12 with a sealant 20 of, for example, low-melting-point glass or low-melting-point metal, whereby these substrates are joined together.

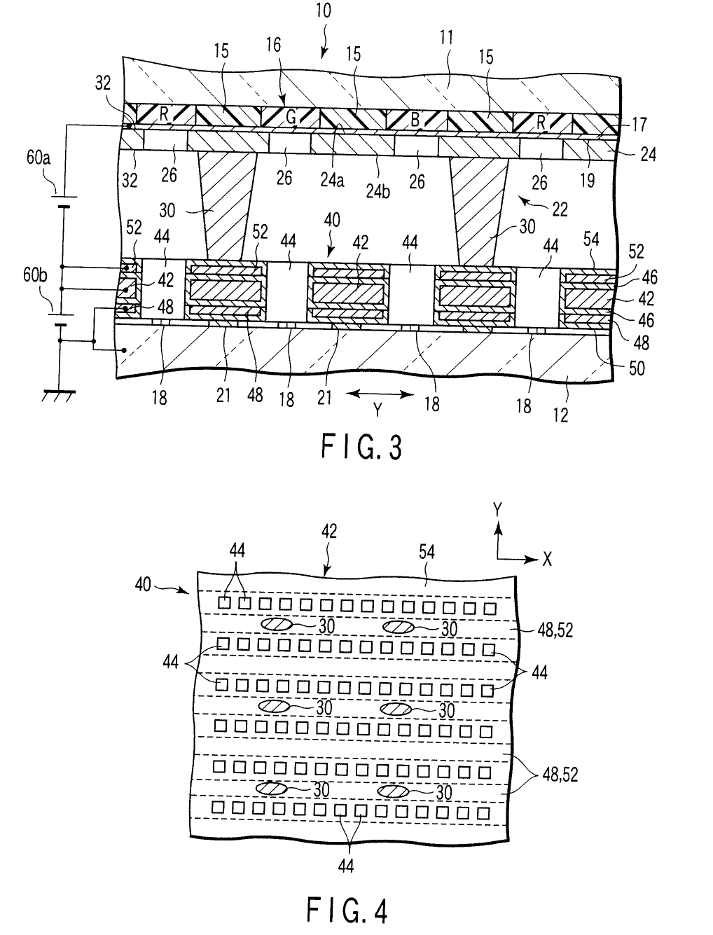

As shown in FIGS. 2 and 3, the SED comprises a spacer structure 22, which is located between the first substrate 11 and the second substrate 12, and a grid unit 40 located between the spacer structure and the second substrate. In the present embodiment, the spacer structure 22 has a supporting substrate 24, formed of a rectangular metal plate, and a large number of columnar spacers 30 set up integrally on one surface of the supporting substrate.

More specifically, the supporting substrate 24 is formed having a rectangular shape that is substantially equal in size to the phosphor screen 16. The supporting substrate 24 has a first surface 24a opposed to the inner surface of the first substrate 11 and a second surface 24b opposed to the inner surface of the second substrate 12, and is located parallel to these substrates. A large number of electron beam apertures 26 are formed in the supporting substrate 24 by etching or the like. The electron beam apertures 26 are arrayed opposite the electron emitting elements 18, individually, and the electron beams emitted from the electron emitting elements pass through the respective electron beam apertures.

The supporting substrate 24 is formed of a plate of, for example, an iron-nickel-based metal with a thickness of 0.1 to 0.25 mm, and the electron beam apertures 26 are formed having a rectangular shape measuring 0.15 to 0.25 mm by 0.15 to 0.25 mm, for example. Formed on the surface of the supporting substrate 24 is a high-resistance film 32 as a dielectric layer obtained by spreading and firing a dielectric material that consists mainly of glass or ceramic. According to the present embodiment, the first and second surfaces 24a and 24b of the supporting substrate 24 and the respective inner wall surfaces of the electron beam apertures 26 are covered by the high-resistance film 32 of Li-based alkaline borosilicic acid glass with a thickness of about 10 μm. The supporting substrate 24 is provided in a manner such that its first surface 24a is in surface contact with the inner surface of the first substrate 11 with the getter film 19, metal back 17, and phosphor screen 16 between them.

If the longitudinal direction and the lateral direction of the first substrate 11 and the second substrate 12 are X and Y, respectively, the electron beam apertures 26 in the supporting substrate 24 are arrayed at a predetermined pitch in the direction X and at a pitch larger than the X-direction pitch in the direction Y. The phosphor layers R, G and B that are formed in the first substrate 11 and the electron emitting elements 18 on the second substrate 12 are arrayed at the same pitch as the electron beam apertures 26 with respect to the directions X and Y, and face the electron beam apertures, individually. Thus, the electron emitting elements 18 face their corresponding phosphor layers through the electron beam apertures 26, individually.

The spacers 30 are set up integrally on the second surface 24b of the supporting substrate 24 and are situated between the electron beam apertures 26 that are arranged in the direction Y. The respective extended ends of the spacers 30 abut the grid unit 40, which will be mentioned later. Each of the spacers 30 is tapered so that its diameter is reduced from the side of the supporting substrate 24 toward its extended end. The cross section of each spacer 30 in a direction parallel to the grid surface is substantially elliptic.

The spacer structure 22 constructed in this manner is located between the first substrate 11 and the second substrate 12. In the spacer structure 22, moreover, the supporting substrate 24 is in surface contact with the first substrate 11, and the respective extended ends of the spacers 30 abut the inner surface of the second substrate 12 with interposing the grid unit 40 therebetween, thereby supporting an atmospheric load that acts on these substrates and keeping the space between the substrates at a predetermined value.

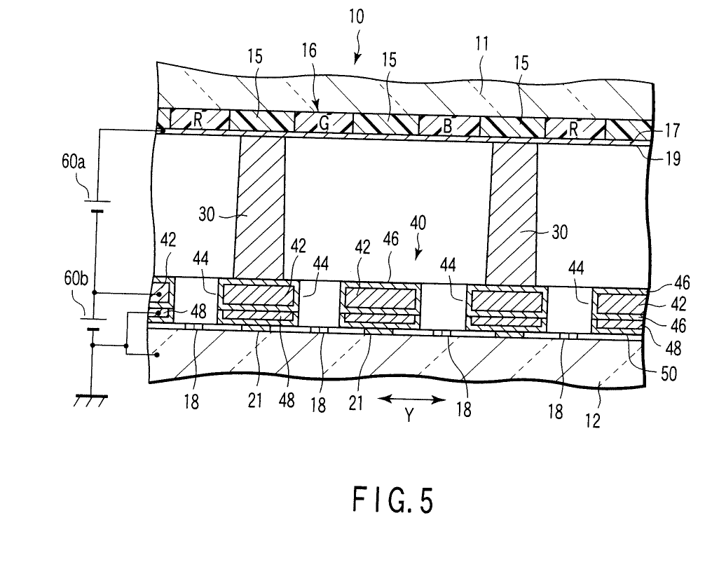

As shown in FIGS. 2 to 4, the grid unit 40 has a grid 42 in the form of a rectangular plate that is substantially equal in size to the phosphor screen 16. The grid 42 has two surfaces opposed to the inner surface of the first substrate 11 and the inner surface of the second substrate 12 and is located parallel to these substrates. A large number of electron beam apertures 44 are formed in the grid 42 by etching or the like. The electron beam apertures 44 are arrayed at a predetermined pitch in the direction X and at a pitch larger than the X-direction pitch in the direction Y. The electron beam apertures 44 are arrayed opposite the electron emitting elements 18, individually, and the electron beams emitted from the electron emitting elements pass through the electron beam apertures 44, respectively.

The grid 42 is formed a plate of, for example, an iron-nickel-based metal with a thickness of 0.1 to 0.25 mm, and the electron beam apertures 44 are rectangular. The surface of the grid 42 including the respective inner surfaces of the electron beam apertures 44 is covered by a first dielectric layer 46 with a thickness of about 10 μm. The first dielectric layer 46 is formed by spreading and firing a dielectric material that consists mainly of glass or ceramic, e.g., Li-based alkaline borosilicic acid glass.

Conductive layers 48 of a metal, such as aluminum, copper, or silver, are formed covering the first dielectric layer 46 on that surface of the grid 42 on the side of the second substrate 12. The conductive layers 48 are formed over the whole surface of the grid 42 except the electron beam apertures 44. In the present embodiment, the conductive layers 48 are in the form of striped-shaped conductive layers that individually extend in the direction X and are situated between the electron beam apertures 44 that are arranged side by side in the direction Y.

A second dielectric layer 50 is formed covering the conductive layers 48 on that surface of the grid 42 on the side of the second substrate 12. The second dielectric layer 50 is formed by spreading and firing a dielectric material that consists mainly of glass or ceramic, e.g., Li-based alkaline borosilicic acid glass.

Another set of conductive layers 52 of a metal, such as aluminum, copper, or silver, are formed covering the first dielectric layer 46 on that surface of the grid 42 on the side of the first substrate 11. The conductive layers 52 are formed over the whole one surface of the grid 42 except the electron beam apertures 44. In the present embodiment, the conductive layers 52 are in the form of striped-shaped conductive layers that individually extend in the direction X and are situated between the electron beam apertures that are arranged side by side in the direction Y. The conductive layers 52 and the conductive layers 48 are formed by screen printing, vapor deposition, sputtering, CVD, etc.

A third dielectric layer 54 is formed covering the conductive layers 52 on that surface of the grid 42 on the side of the first substrate 11. The third dielectric layer 54 is formed by spreading and firing a dielectric material that consists mainly of glass or ceramic, e.g., Li-based alkaline borosilicic acid glass.

The grid unit 40 constructed in this manner is provided on the second substrate 12 with the second dielectric layer 50 in contact with the inner surface of the second substrate. The electron beam apertures 44 of the grid unit 40 individually face their corresponding electron emitting elements 18. In the present embodiment, the grid unit 40 is located overlapping the wires 21 that are formed on the second substrate. Thus, a slight gap, e.g., a gap of about 20 μm, is defined between the dielectric layer 50 and the inner surface of the second substrate 12. This gap is formed so as to account for 50% or less of the diameter of each electron beam aperture 44. Further, the wires 21 function as gap defining members that define gaps between the grid unit 40 and the second substrate 12.

The plurality of spacers 30 that constitute the spacer structure 22 abut the third dielectric layer 54 of the grid unit 40 in regions between the electron beam apertures 44, individually. Thus, the grid unit 40 is held between the spacers 30 and the second substrate 12.

The SED comprises a voltage supply portion that applies voltage to the grid unit 40 and the metal back 17 of the first substrate 11. The voltage supply portion has a first power source 60a that applies a high voltage of, e.g., about 8 kV to the metal back 17 and a second power source 60b that applies a voltage of, e.g., about 1 kV to the conductive layers 52. The second substrate 12 and the conductive layers 48 that are situated between the grid 42 and the second substrate 12 are connected to the ground potential.

In displaying an image on the SED constructed in this manner, the electron beams emitted from the electron emitting elements 18 are accelerated by an anode voltage that is applied to the phosphor screen 16 and the metal back 17 and collided with the phosphor screen 16. Thereupon, the phosphor layers of the phosphor screen 16 are excited to luminescence and display the image. As this is done, the grid 42 to which the voltage is applied functions as an extraction electrode for extracting the electron beams from the electron emitting elements 18. The conductive layers 52 on the side of the first substrate 11 to which the voltage is applied have a function to converge the electron beams transmitted through the electron beam apertures 44 toward the phosphor layers.

According to the SED constructed in this manner, the grid unit 40 that has the grid 42 and the conductive layers 48 is provided on the inner surface of the second substrate 12, a predetermined voltage is applied to the grid 42, and the conductive layers 48 that are situated between the grid and the second substrate are connected to the ground potential. Accordingly, the grid unit 40 can substantially reduce the intensity of an electric field that is generated on the inner surface of the second substrate 12 to zero, i.e., 0 V/m, thereby suppressing the occurrence of electric discharge (creeping discharge). Thus, an SED with improved reliability and display quality can be provided.

The grid 42 is provided near the electron emitting elements 18 and functions also as an extraction electrode. Therefore, the electron beams can be emitted efficiently. Further, the grid unit 40 has the other conductive layers 52 that are provided on the side of the first substrate 11, and the convergence of the electron beams on the phosphor layers can be improved by applying voltage to the conductive layers. Based on these circumstances, an SED with further improved display quality can be obtained.

The following is a description of a second embodiment of the invention. According to the second embodiment, as shown in FIG. 5, a grid unit 40 has a grid 42, a first dielectric layer 46, conductive layers 48, and a second dielectric layer 50. Conductive layers and a third dielectric layer on the side of a first substrate 1 are omitted. The grid 42 is provided over a second substrate 12 with the first dielectric layer 46, conductive layers 48, and second dielectric layer 50 between them. The grid 42 is connected to a second power source 60b, while the conductive layers 48 are connected to the ground potential.

A plurality of spacers 30 are provided in place of the aforementioned spacer structure between the grid unit 40 and the first substrate 11. These spacers 30 are columnar or plate-shaped. One end of each spacer 30 abuts the first dielectric layer 46 of the grid unit 40 between adjacent electron beam apertures 44, and the other end thereof abuts the inner surface of the first substrate 11 with interposing a getter film 19, a metal back 17, and light shielding layers 15 between them. Thus, the spacers 30 support an atmospheric load that acts on the first substrate 11 and the second substrate 12, thereby keeping the space between the substrates at a predetermined value.

In the second embodiment, other configurations are the same as those of the foregoing first embodiment, so that like reference numerals are used to designate like portions, and a detailed description thereof is omitted.

According to the SED constructed in this manner, the grid unit 40 that has the grid 42 and the conductive layers 48 is provided on the inner surface of the second substrate 12, a predetermined voltage is applied to the grid 42, and the conductive layers 48 that are situated between the grid and the second substrate are connected to the ground potential. Accordingly, the grid unit 40 can reduce the intensity of an electric field that is generated on the inner surface of the second substrate 12, thereby suppressing the occurrence of electric discharge. The grid 42 is provided near the electron emitting elements 18 and functions also as an extraction electrode. Thus, an SED with improved reliability and display quality can be provided.

The present invention is not limited directly to the embodiments described above, and its components may be embodied in modified forms without departing from the spirit of the invention. Further, various inventions may be made by suitably combining a plurality of components described in connection with the foregoing embodiments. For example, some of the components according to the embodiments may be omitted. Furthermore, components according to different embodiments may be combined as required.

In the foregoing embodiments, the gap defining members that define the gaps between the second substrate and the grid unit are formed of the wires on the second substrate. Alternatively, however, they may be formed of a plurality of independent spacers.

The diameter and height of the spacers, the dimensions and materials of the other components, the voltage applied to the grid, etc. are not limited to the foregoing embodiments, but may be suitably selected as required. This invention is not limited to image display devices that use surface-conduction electron emitting elements as electron sources, but may be also applied to image display devices that use other electron sources, such as the field-emission type, carbon nanotubes, etc.

What is claimed is:

1. An image display device comprising:
a first substrate having a phosphor screen formed thereon;
a second substrate located opposite the first substrate with a gap and provided with a plurality of electron emission sources which excite the phosphor screen;
a plurality of spacers which are located between the first and second substrates and support an atmospheric load acting on the first and second substrates; and
a grid unit provided between the spacers and the second substrate,
the grid unit including a plate-shaped grid which has a plurality of electron beam apertures opposed to the electron emission sources, individually, and is located opposite the second substrate and to which a predetermined voltage is applied, a first dielectric layer which covers an outer surface of the grid, a conductive layer provided between the first dielectric layer and the second substrate and connected to a ground potential, and a second dielectric layer formed covering the conductive layer and situated between the conductive layer and the second substrate.

2. An image display device according to claim 1, wherein the grid unit is arranged so that the second dielectric layer is in contact with the second substrate.

3. An image display device according to claim 1, wherein the grid unit is opposed to the second substrate with a gap, and a gap defining member is located between the grid unit and the second substrate.

4. An image display device according to claim 3, wherein the gap between the grid unit and the second substrate is defined so as to account for 50% or less of the diameter of each of the electron beam apertures.

5. An image display device according to claim 1, wherein the grid unit has another conductive layer, which is formed covering the first dielectric layer and faces the first substrate, and a third dielectric layer formed covering the other conductive layer.

6. An image display device according to claim 1, which further comprises a spacer structure located between the first substrate and the grid unit, the spacer structure including a plate-shaped supporting substrate which faces the first substrate and has a plurality of electron beam apertures opposed to the electron emission sources, individually, and the spacers set up on a surface of the supporting substrate.

7. An image display device according to claim 6, wherein the supporting substrate has a first surface in contact with the first substrate and a second surface opposed to the grid unit across a gap, and each of the spacers is set up on the second surface and has a distal end portion which abuts the grid unit.

8. An image display device according to claim 1, wherein the spacers are columnar spacers.
